(19) United States
(12) Patent Application Publication
(10) Pub. No.: US 2005/0020767 A1
(43) Pub. Date: Jan. 27, 2005

(54) High performance aqueous polyurethanes dispersion and methods of fabricating the same

(76) Inventors: Huey-Huey Lo, Taoyuan City (TW); Wan-Hsiang Chen, Taichung (TW); Ruei-Shin Chen, Hsinchu (TW); Chih-Chien Chen, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/878,789

(22) Filed: Jun. 28, 2004

Related U.S. Application Data
(63) Continuation-in-part of application No. 10/000,220, filed on Dec. 4, 2001, now abandoned.

(51) Int. Cl. C08L 75/00

(52) U.S. Cl. 524/839; 524/840

(57) ABSTRACT

Disclosed are high performance aqueous polyurethanes and methods of making the same. The aqueous polyurethane is prepared by prepolymerizing the following components (a), (b), and (c) in the absence of aliphatic or cycloaliphatic diisocyanates; and chain-extending the hydrophilic prepolymer with component (d): (a) 10-40 wt % of an aromatic diisocyanate consisting of toluene diisocyanate (TDI); (b) 1-15 wt % of a compound containing active hydrogen and a hydrophilic group or a group capable of forming hydrophilicity; (c) 30-80 wt % of a polyol; and (d) 0.1-5 wt % of a chain extender having active hydrogen. The aqueous dispersions of the polyurethane have good storage stability and the dried films produced therefrom possess superior mechanical properties.

### BACKGROUND OF THE INVENTION

This application is a continuation in part of co-pending Application U.S. Ser. No. 10/000,220 filed on Dec. 4, 2001.

### FIELD OF THE INVENTION

The present invention relates in general to aqueous polyurethanes (PU). More particularly, it relates to high performance aqueous polyurethanes dispersion and methods of making the same.

### DESCRIPTION OF THE RELATED ART

Polyurethane is a very important highly-functional resin. However, over 90 percent of polyurethanes contain quite a lot of organic solvent such as N,N-dimethylformamide or toluene, which pollutes the environment and endangers the health of operators. Since environment protection is gaining world-wide attention, and pollution laws are becoming stricter, the polyurethane resin industry has made revolutionary progress in recent years by using low-polluting aqueous polyurethanes instead of high-polluting, solvent type polyurethanes.

A conventional process for producing aqueous polyurethane resins includes prepolymerizing a polyol, a hydrophilic group-containing dihydric alcohol, and a diisocyanate in a high-boiling-point organic solvent; neutralizing the prepolymer with a tertiary amine to ionize the hydrophilic group; dispersing the neutralized prepolymer in water; and finally chain-extending the dispersed prepolymer to obtain aqueous polyurethane dispersions.

However, in the conventional process for producing an aqueous polyurethane, part of the terminal isocyanate (—NCO) groups of the prepolymer will be consumed by water upon dispersing, and converted into amino groups. As a result, the isocyanate groups cannot effectively react with a chain extender, a diamine for example, to extend the chains and raise the molecular weight, thus detrimentally affecting the physical properties of resulting polyurethanes. This problem is especially serious when the terminal groups are aromatic isocyanates, which are highly reactive with water. Thus, the polyurethanes derived from aromatic isocyanates are very poor in mechanical properties and have no commercial value.

Accordingly, even though aqueous polyurethanes have been commercialized for over than twenty years, all available products are derived from aliphatic or cycloaliphatic diisocyanates, which are less reactive with water, for example, isophorone diisocyanate (IPDI), hexamethylene diisocyanate (HDI), and 4,4′-dicyclohexylmethane diisocyanate (H₁₂MDI). However, because aliphatic and cycloaliphatic diisocyanates are quite expensive, using the derived aqueous polyurethanes costs much more than using conventional solvent-type polyurethanes, and this has significantly restricted their popularization in industry. Aqueous polyurethanes derived from low-cost aromatic diisocyanates are therefore desired. Before this, the problem of poor chain extension due to their high reactivity with water must be solved first.

Numerous attempts have been made to reduce the reactivity of terminal isocyanate groups with water by incorporating aliphatic or cycloaliphatic diisocyanates into aromatic diisocyanates. However, these methods cannot provide a real low-cost aqueous polyurethane. See, for example, U.S. Pat. Nos. 5,714,561, 5,852,105, 5,905,113, 5,334,690 and 5,231,130. Other conventional methods require either complicated process or large amounts of organic solvent. See, for example, U.S. Pat. Nos. 5,770,264, 5,470,907, 5,714,561, and 5,306,764.

### SUMMARY OF THE INVENTION

It is therefore an object of the invention to solve the above-mentioned problem and provide an aqueous polyurethane dispersion and a method of making the same.

It is another object of the invention to provide an aqueous polyurethane dispersion which is prepared by aromatic diisocyanate consisting of toluene diisocyanate (TDI).

It is a further object of the invention to provide an aqueous polyurethane dispersion that has good storage stability and superior mechanical properties.

It is a further object of the invention to provide an aqueous polyurethane dispersion which is useful in industrial coating or surface treatment of leather or textiles.

According to one feature of the present invention, a prepolymer is prepared by first reacting an aromatic diisocyanate with a compound containing active hydrogen and a hydrophilic group or a group capable of forming hydrophilicity, followed by adding a polyol to proceed pre-polymerization reaction. This gives a prepolymer with the hydrophilic groups or the groups capable of forming hydrophilicity evenly distributed among the prepolymer chains, and with terminal isocyanate groups, which are relatively hydrophobic, wrapped in the internal part of twisted prepolymer chains. Accordingly, the terminal isocyanate groups are less consumed when dispersing the prepolymer in water, and the chain extension can proceed to raise the molecular weight effectively.

According to another feature of the invention, the NCO content of the prepolymer dispersion is closely monitored, such that a chain extender can be added to the dispersion before a drastic reaction between the terminal NCO groups and water. Preferably, 9.1-5 wt % of the chain extender is added. Thereby, a stable aqueous dispersion of a high-molecular weight polyurethane can be afforded. The aqueous polyurethane dispersions of the invention are generally storable at room temperature for over one year. In addition, because the polyurethane has a high molecular weight, a dried film produced therefrom generally exhibits excellent mechanical properties, for example, tensile strength of above 400 kg/cm², ultimate elongation of above 400%, 100% modulus of above 80 kg/cm².

### DETAILED DESCRIPTION OF THE INVENTION

The aqueous polyurethane dispersion of the present invention is prepared by following steps:
(A) first reacting (a) 10-40 wt % of an aromatic diisocyanate with (b) 1-15 wt % of a compound containing active hydrogen and a hydrophilic group or a group capable of forming hydrophilicity, to form a diisocyanate-terminated compound containing a hydrophilic group or a group capable of forming hydrophilicity;
(B) then reacting the diisocyanate-terminated compound with (c) 30-80 wt % of a polyol to form a prepolymer containing a hydrophilic group or a group capable of forming hydrophilicity, and neutralizing the prepolymer;
(C) dispersing the prepolymer in water to form an aqueous dispersion; and
(D) chain-extending the dispersed prepolymer to obtain an aqueous polyurethane dispersion by adding thereto (d) 0.1-5 wt % of an amine chain extender, wherein the wt % is based on the total weight of components (a), (b), (c), and (d).

The polyurethanes of the present invention are prepared in the absence of aliphatic or cycloaliphatic diisocyanates, or acrylic resins which are required in conventional methods for making aromatic diisocyanate-derived polyurethane. The diisocyanate component (a) is an aromatic diisocyanate, which costs much less than aliphatic or cycloaliphatic diisocyanates.

Representative examples of suitable aromatic diisocyanates include toluene diisocyanate (TDI), p-phenylene diisocyanate (PPDI), diphenylmethane diisocyanate (MDI), and p,p′-bisphenyl diisocyanate (BPDI). Preferably, the aromatic diisocyanate consist of toluene diisocyanate (TDI).

A compound containing active hydrogen and a hydrophilic group or a group capable of forming hydrophilicity is used as component (b) in preparing polyurethanes of the present invention. The hydrophilic groups include ionic groups such as —COO⁻, —SO₃⁻, and N⁺R₄ (R=alkyl), and non-ionic groups. Illustrative of such compounds are dimethylol propionic acid (DMPA), dimethylol butanoic acid (DMBA), polyethylene oxide glycol, bis(hydroxylethyl) amine, and sodium 3-bis(hydroxyethyl) aminopropanesulfonate. These compounds can be used either alone or in combination.

Polyols such as diols or more highly functional polyols are used as component (c) in the present invention, including, for example, polyester polyols, polyether polyols, polycarbonate polyols, polycaprolactone polyols, and polyacrylate polyols. Illustrative of suitable polyols are poly(butanediol-co-adipate) glycol (PBA), polytetramethylene glycol (PTMEG), poly(hexanediol-co-adipate) glycol (PHA), poly(ethylene-co-adipate) glycol, (PEA), polypropylene glycol, and polyethylene glycol. These polyols can be used either alone or in combination. Preferably, the polyols used herein have a number-average molecular weight between about 200-6,000, more preferably between about 600-3,000.

The component (d) is an amine chain extender. The amine chain extender is different from the polyol used as component (c). Any conventional amine chain extenders having active hydrogen-containing groups may be used. Typical amine chain extenders include diamines, triamines, and tetraamines. Preferred amine chain extenders are diamines of the formula: H₂N—(CH₂)ₘ—NH₂ where m is an integer of 0-12, methyl-1,5-pentamethylene diamine, diethylene triamine (DETA), and triethylene tetraamine (TETA). A most preferred amine chain extender is ethylene diamine.

The present method of making an aqueous polyurethane dispersion is described in detail as below.

First, 10-40 wt % of an aromatic diisocyanate is reacted with 1-15 wt % of a compound containing active hydrogen and a hydrophilic group or a group capable of forming hydrophilicity, to form a diisocyanate-terminated compound containing a hydrophilic group or a group capable of forming hydrophilicity.

Next, the diisocyanate-terminated compound is reacted with (c) 30-80 wt % of a polyol to form a prepolymer containing a hydrophilic group or a group capable of forming hydrophilicity, and then the prepolymer is neutralized.

Next, the prepolymer is dispersed in water to form an aqueous dispersion.

Finally, the dispersed prepolymer is chain-extended to obtain an aqueous polyurethane dispersion by adding thereto 0.1-5 wt % of a chain extender.

The diisocyanate-terminated compound containing a hydrophilic group or a group capable of forming hydrophilicity is preferably prepared at a temperature between about 40-90° C., and more preferably below 60° C. If the reaction temperature is too high, the hydrophilic groups or the groups capable of forming hydrophilicity will be unevenly distributed among the prepolymer chain, thus resulting in an unstable dispersion. The prepolymer containing a hydrophilic group or a group capable of forming hydrophilicity may be prepared at a temperature between about 40-90° C. As the prepolymerization approaches theoretical completion, the reaction mixture is cooled to a temperature below 70° C., and when necessary, a neutralizing agent such as triethylamine (TEA) is added to give a neutralized prepolymer containing a hydrophilic group or a group capable of forming hydrophilicity. Thereafter, the prepolymer is dispersed in water, and the NCO content of the aqueous dispersion is closely monitored. A chain extender, preferably diluted with water, is added to chain-extend the prepolymer. The chain extension can be carried out at room temperature or under heating. After forming the polyurethane dispersion, water can be added to adjust the desired solid content, which is typically in the range between about 10-55 wt %.

With the present invention, aqueous polyurethane dispersions derived from aromatic diisocyanates with high molecular weights and excellent mechanical properties can be achieved. A polyurethane film produced thereby generally exhibits tensile strength of above 320 kg/cm², and ultimate elongation of 320%.

Without intending to limit it in any manner, the present invention will be further illustrated by the following examples.

### EXAMPLE 1

To a reaction vessel equipped with a nitrogen inlet and outlet, 14.07 g of dimethylol propionic acid (DMPA) and 33.33 g of N-methylpyrrolidone (NMP) were added with thorough stirring. After the DMPA was completely dissolved, 67.15 g of a mixture of 80% of 2,4- and 20% of 2,6-toluene diisocyanate (TDI) was added. The mixture was stirred at 60° C. for 1.5 hour, followed by addition of 218.78 g of poly(butanediol-co-adipate) glycol (PBA; Mn=2,000) to proceed prepolymerization. After stirring at 60° C. for 4 hours, the reaction mixture was cooled to 50° C, and then 10.6 g of triethylamine (TEA) was added to neutralize the prepolymer. The neutralization was continued for 20 minutes. Thereafter, 270 g of the neutralized prepolymer was dispersed in 560 g of de-ionized water under stirring at rotor speeds of about 500 rpm. 3.04 g of ethylene diamine (EDA) was diluted with water and added to the above mixture to proceed chain extension before the NCO content of the dispersion has fallen to 1.47 wt %. The chain extension was continued at room temperature for 2 hours, giving an aqueous polyurethane dispersion with 30 wt % solid content.

The dispersion was cast into a film and dried. The dried film was glossy and transparent. The solvent resistance and mechanical properties of the polyurethane film were valuated, and the results are as follows:
Solvent Resistance (Toluene): over 100 times
Tensile strength: 323 kg/cm²
100% modulus: 88 kg/cm²
Ultimate elongation: 330%

### EXAMPLE 2

To a reaction vessel equipped with a nitrogen inlet and outlet, 14.07 g of dimethylol propionic acid (DMPA) and 33.33 g of N-methylpyrrolidone (NMP) were added with thorough stirring. After the DMPA was completely dissolved, 67.15 g of a mixture of 80% of 2,4- and 20% of 2,6-toluene diisocyanate (TDI) was added. The mixture was stirred at 60° C. for 1.5 hour, followed by addition of 218.78 g of polytetramethylene glycol (PTMEG; Mn=1,000) to proceed prepolymerization. After stirring at 60° C. for 4 hours, the reaction mixture was cooled to 50° C., and then 10.6 g of triethylamine (TEA) was added to neutralize the prepolymer. The neutralization was continued for 20 minutes. Thereafter, 270 g of the neutralized prepolymer was dispersed in 450 g of de-ionized water under stirring at rotor speeds of about 500 rpm. 3.10 g of ethylene diamine (EDA) was diluted with water and added to the above mixture to proceed chain extension before the NCO content of the dispersion has fallen to 2.03 wt %. The chain extension was continued at room temperature for 2 hours, giving an aqueous polyurethane dispersion with 33 wt % solid content.

The dispersion was cast into a film and dried. The dried film did not dissolve in methyl ethyl ketone and toluene. The solvent resistance and mechanical properties of the polyurethane film were valuated, and the results are as follows:
Solvent Resistance (Toluene): over 300 times
Tensile strength: 450 kg/cm²
100% modulus: 60 kg/cm²
Ultimate elongation: 370%

### EXAMPLE 3

To a reaction vessel equipped with a nitrogen inlet and outlet, 12.19 g of dimethylol propionic acid (DMPA) and 28.9 g of N-methylpyrrolidone (NMP) were added with thorough stirring. After the DMPA was completely dissolved, 28.19 g of a mixture of 80% of 2,4- and 20% of 2,6-toluene diisocyanate (TDI) was added. The mixture was stirred at 60° C. for 1.5 hour, followed by addition of 189.61 g of poly(hexanediol-co-adipate) glycol (PHA; Mn=2,000) to proceed prepolymerization. After stirring at 60° C. for 4 hours, the reaction mixture was cooled to 50° C., and then 9.2 g of triethylamine (TEA) was added to neutralize the prepolymer. The neutralization was continued for 20 minutes. Thereafter, 270 g of the neutralized prepolymer was dispersed in 400 g of de-ionized water under stirring at rotor speeds of about 500 rpm. 2.63 g of ethylene diamine (EDA) was diluted with water and added to the above mixture to proceed chain extension before the NCO content of the dispersion has fallen to 1.47 wt %. The chain extension was continued at room temperature for 2 hours, giving an aqueous polyurethane dispersion with 35 wt % solid content.

The dispersion was cast into a film and dried. The dried film did not dissolve in methyl ethyl ketone and toluene. The solvent resistance and mechanical properties of the polyurethane film were valuated, and the results are as follows:
Solvent Resistance (Toluene): over 300 times
Tensile strength: 410 kg/cm²
100% modulus: 60 kg/cm²
Ultimate elongation: 380%

### EXAMPLE 4

To a reaction vessel equipped with a nitrogen inlet and outlet, 16.88 g of dimethylol propionic acid (DMPA) and 31.1 g of N-methylpyrrolidone (NMP) were added with thorough stirring. After the DMPA was completely dissolved, 69.75 g of a mixture of 80% of 2,4- and 20% of 2,6-toluene diisocyanate (TDI) was added. The mixture was stirred at 60° C. for 1.5 hour, followed by addition of 193.37 g of polytetramethylene glycol (PTMEG; Mn=2,000) to proceed prepolymerization. After stirring at 60° C. for 4 hours, the reaction mixture was cooled to 50° C., and then 12.7 g of triethylamine (TEA) was added to neutralize the prepolymer. The neutralization was continued for 20 minutes. Thereafter, 270 g of the neutralized prepolymer was dispersed in 490 g of de-ionized water under stirring at rotor speeds of about 500 rpm. 2.88 g of ethylene diamine (EDA) was diluted with water and added to the above mixture to proceed chain extension before the NCO content of the dispersion has fallen to 2.88 wt %. The chain extension was continued at room temperature for 2 hours, giving an aqueous polyurethane dispersion with 27 wt % solid content.

The dispersion was cast into a film and dried. The solvent resistance and mechanical properties of the polyurethane film were valuated, and the results are as follows:
Solvent Resistance (Toluene): over 600 times
Tensile strength: 400 kg/cm²
100% modulus: 80 kg/cm²
Ultimate elongation: 470%

### EXAMPLE 5

To a reaction vessel equipped with a nitrogen inlet and outlet, 6.70 g of dimethylol propionic acid (DMPA) and 50.0 g of N-methylpyrrolidone (NMP) were added with thorough stirring. After the DMPA was completely dissolved, 25.01 g of 4,4′-diphenylmethane diisocyanate (MDI) was added. The mixture was stirred at 60° C. for 1.5 hour, followed by addition of 152.68 g of polypropylene glycol (PPG; Mn=2,000) to proceed prepolymerization. After stirring at 60° C. for 4 hours, 40.62 g of a mixture of 80% of 2,4- and 20% of 2,6-toluene diisocyanate (TDI) was added, and left stirring for additional 2.5 hours. The reaction mixture was cooled to 50° C., and then 5.05 g of triethylamine (TEA) was added to neutralize the prepolymer. The neutralization was continued for 20 minutes. Thereafter, 190 g of the neutralized prepolymer was dispersed in 182 g of de-ionized water under stirring at rotor speeds of about 500 rpm. 2.14 g of ethylene diamine (EDA) was diluted with water and added to the above mixture to proceed chain extension before the NCO content of the dispersion has fallen to 1.91 wt %. The chain extension was continued at room temperature for 2 hours, giving an aqueous polyurethane dispersion with 45 wt % solid content.

The dispersion was cast into a film and dried. The dried film did not dissolve in methyl ethyl ketone and NMP, and exhibited excellent toluene resistance (over 1,000 times).

### EXAMPLE 6

To a reaction vessel equipped with a nitrogen inlet and outlet, 10.85 g of dimethylol propionic acid (DMPA) and 50.0 g of N-methylpyrrolidone (NMP) were added with thorough stirring. After the DMPA was completely dissolved, 34.29 g of 4,4′-diphenylmethane diisocyanate (MDI) was added. The mixture was stirred at 60° C. for 1.5 hour, followed by addition of 133.35 g of PTMEG (Mn=1,000) to proceed prepolymerization. After stirring at 60° C. for 4 hours, 35.80 g of a mixture of 80% of 2,4- and 20% of 2,6-toluene diisocyanate (TDI) was added, and left stirring for additional 2.5 hours. The reaction mixture was cooled to 50° C., and then 8.18 g of triethylamine (TEA) was added to neutralize the prepolymer. The neutralization was continued for 20 minutes. Thereafter, 200 g of the neutralized prepolymer was dispersed in 214 g of de-ionized water under stirring at rotor speeds of about 500 rpm. 1.52 g of ethylene diamine (EDA) was diluted with water and added to the above mixture to proceed chain extension before the NCO content of the dispersion has fallen to 1.53 wt %. The chain extension was continued at room temperature for 2 hours, giving an aqueous polyurethane dispersion with 20 wt % solid content.

The dispersion was cast into a film and dried. The dried film did not dissolve in methyl ethyl ketone and NMP.

### EXAMPLE 7

To a reaction vessel equipped with a nitrogen inlet and outlet, 12.06 g of dimethylol propionic acid (DMPA) and 50.0 g of N-methylpyrrolidone (NMP) were added with thorough stirring. After the DMPA was completely dissolved, 21.47 g of 4,4′-diphenylmethane diisocyanate (MDI) was added. The mixture was stirred at 60° C. for 1.5 hour, followed by addition of 153.07 g of PTMEG (Mn=2,000) to proceed prepolymerization. After stirring at 60° C. for 4 hours, 35.80 g of a mixture of 80% of 2,4- and 20% of 2,6-toluene diisocyanate (TDI) was added, and left stirring for additional 2.5 hours. The reaction mixture was cooled to 50° C., and then 9.1 g of triethylamine (TEA) was added to neutralize the prepolymer. The neutralization was continued for 20 minutes. Thereafter, 200 g of the neutralized prepolymer was dispersed in 241 g of de-ionized water under stirring at rotor speeds of about 500 rpm. 1.51 g of ethylene diamine (EDA) was diluted with water and added to the above mixture to proceed chain extension before the NCO content of the dispersion has fallen to 1.36 wt %. The chain extension was continued at room temperature for 2 hours, giving an aqueous polyurethane dispersion with 35 wt % solid content.

The dispersion was cast into a film and dried. The dried film did not dissolve in methyl ethyl ketone (MEK) and NMP, and exhibited excellent MEK resistance (over 1,000 times).

### EXAMPLE 8

To a reaction vessel equipped with a nitrogen inlet and outlet, 10.72 g of dimethylol propionic acid (DMPA) and 80.2 g of N-methylpyrrolidone (NMP) were added with thorough stirring. After the DMPA was completely dissolved, 40.0 g of 4,4′-diphenylmethane diisocyanate (MDI) was added. The mixture was stirred at 60° C. for 1.5 hour, followed by addition of 80 g of PBA (Mn=1,000) to proceed prepolymerization. After stirring at 60° C. for 4 hours, 27.84 g of a mixture of 80% of 2,4- and 20% of 2,6-toluene diisocyanate (TDI) was added, and left stirring for additional 2.5 hours. The reaction mixture was cooled to 50° C., and then 9.87 g of triethylamine (TEA) was added to neutralize the prepolymer. The neutralization was continued for 20 minutes. Thereafter, 190 g of the neutralized prepolymer was dispersed in 465 g of de-ionized water under stirring at rotor speeds of about 500 rpm. 2.86 g of ethylene diamine (EDA) was diluted with water and added to the above mixture to proceed chain extension before the NCO content of the dispersion has fallen to 1.82 wt %. The chain extension was continued at room temperature for 2 hours, giving an aqueous polyurethane dispersion with 20 wt % solid content.

The dispersion was cast into a film and dried. The dried film was transparent and did not dissolve in MEK and NMP.

### EXAMPLE 9

To a reaction vessel equipped with a nitrogen inlet and outlet, 26.8 g of dimethylol propionic acid (DMPA) and 43.3 g of N-methylpyrrolidone (NMP) were added with thorough stirring. After the DMPA was completely dissolved, 37.5 g of 4,4′-diphenylmethane diisocyanate (MDI) was added. The mixture was stirred at 60° C. for 1.5 hour, followed by addition of 100.0 g of PBA (Mn=1,000) to proceed prepolymerization. After stirring at 60° C. for 4 hours, 43.5 g of a mixture of 80% of 2,4- and 20% of 2,6-toluene diisocyanate (TDI) was added, and left stirring for additional 2.5 hours. The reaction mixture was cooled to 50° C., and then 20.2 g of triethylamine (TEA) was added to neutralize the prepolymer. The neutralization was continued for 20 minutes. Thereafter, 180 g of the neutralized prepolymer was dispersed in 540 g of de-ionized water under stirring at rotor speeds of about 500 rpm. 1.28 g of ethylene diamine (EDA) was diluted with water and added to the above mixture to proceed chain extension before the NCO content of the dispersion has fallen to 1.17 wt %. The chain extension was continued at room temperature for 2 hours, giving an aqueous polyurethane dispersion with 20 wt % solid content.

The dispersion was cast into a film and dried. The dried film did not dissolve in methyl ethyl ketone (MEK) and NMP, and exhibited excellent toluene resistance (over 1,000 times).

### EXAMPLE 10

To a reaction vessel equipped with a nitrogen inlet and outlet, 16.80 g of dimethylol propionic acid (DMPA) and 40.0 g of N-methylpyrrolidone (NMP) were added with thorough stirring. After the DMPA was completely dissolved, 40.0 g of 4,4′-diphenylmethane diisocyanate (MDI) was added. The mixture was stirred at 60° C. for 1.5 hour, followed by addition of 80.0 g of PTMEG (Mn=1,000) to proceed prepolymerization. After stirring at 60° C. for 4 hours, 27.84 g of a mixture of 80% of 2,4- and 20% of 2,6-toluene diisocyanate (TDI) was added, and left stirring for additional 2.5 hours. The reaction mixture was cooled to 50° C., and then 9.87 g of triethylamine (TEA) was added to neutralize the prepolymer. The neutralization was continued for 20 minutes. Thereafter, 150 g of the neutralized prepolymer was dispersed in 450 g of de-ionized water under stirring at rotor speeds of about 500 rpm. 2.10 g of ethylene diamine (EDA) was diluted with water and added to the above mixture to proceed chain extension before the NCO content of the dispersion has fallen to 1.73 wt %. The chain extension was continued at room temperature for 2 hours, giving an aqueous polyurethane dispersion with 20 wt % solid content.

The dispersion was cast into a film and dried. The mechanical properties of the polyurethane film were valuated, and the results are as follows:
Tensile strength: 400 kg/cm²
100% modulus: 160 kg/cm²
Ultimate elongation: 330%

### EXAMPLE 11

To a reaction vessel equipped with a nitrogen inlet and outlet, 13.4 g of dimethylol propionic acid (DMPA) and 36.2 g of N-methylpyrrolidone (NMP) were added with thorough stirring. After the DMPA was completely dissolved, 40.0 g of 4,4′-diphenylmethane diisocyanate (MDI) was added. The mixture was stirred at 60° C. for 1.5 hour, followed by addition of 100.0 g of PTMEG (Mn=1,000) to proceed prepolymerization. After stirring at 60° C. for 4 hours, 34.8 g of a mixture of 80% of 2,4- and 20% of 2,6-toluene diisocyanate (TDI) was added, and left stirring for additional 2.5 hours. The reaction mixture was cooled to 50° C., and then 10.1 g of triethylamine (TEA) was added to neutralize the prepolymer. The neutralization was continued for 20 minutes. Thereafter, 150 g of the neutralized prepolymer was dispersed in 690 g of de-ionized water under stirring at rotor speeds of about 500 rpm. 2.86 g of ethylene diamine (EDA) was diluted with water and added to the above mixture to proceed chain extension before the NCO content of the dispersion has fallen to 2.10 wt %. The chain extension was continued at room temperature for 2 hours, giving an aqueous polyurethane dispersion with 15 wt % solid content.

The dispersion was cast into a film and dried. The dried film did not dissolved in MEK and NMP. The solvent resistance and the mechanical properties of the polyurethane film were valuated, and the results are as follows:
Solvent Resistance (Toluene): over 1,000 times
Tensile strength: 400 kg/cm²
100% modulus: 160 kg/cm²
Ultimate elongation: 330%

### EXAMPLE 12

In a reaction vessel equipped with a nitrogen inlet and outlet, 5.63 g of dimethylol propionic acid (DMPA) were added to 127.13 g of a mixture of 80% of 2,4- and 20% of 2,6-toluene diisocyanate (TDI). The mixture was stirred at 60° C. for 1.5 hour, followed by addition of 117.84 g of PPG (Mn=600) to proceed prepolymerization. After stirring at 60° C. for 4 hours, the reaction mixture was cooled to 50° C., and then 4.2 g of triethylamine (TEA) was added to neutralize the prepolymer. The neutralization was continued for 20 minutes. Thereafter, 160 g of the neutralized prepolymer was dispersed in 630 g of de-ionized water under stirring at rotor speeds of about 500 rpm. 4.13 g of ethylene diamine (EDA) was diluted with water and added to the above mixture to proceed chain extension before the NCO content of the dispersion has fallen to 4.62 wt %. The chain extension was continued at room temperature for 2 hours, giving an aqueous polyurethane dispersion with 20 wt % solid content.

### EXAMPLE 13

In a reaction vessel equipped with a nitrogen inlet and outlet, 5.63 g of dimethylol propionic acid (DMPA) were added to 151.69 g of a mixture of 80% of 2,4- and 20% of 2,6-toluene diisocyanate (TDI). The mixture was stirred at 60° C. for 1.5 hour, followed by addition of 122.68 g of PPG (Mn=600) to proceed prepolymerization. After stirring at 60° C. for 4 hours, the reaction mixture was cooled to 50° C., and then 5.0 g of triethylamine (TEA) was added to neutralize the prepolymer. The neutralization was continued for 20 minutes. Thereafter, 180 g of the neutralized prepolymer was dispersed in 700 g of de-ionized water under stirring at rotor speeds of about 500 rpm. 5.57 g of ethylene diamine (EDA) was diluted with water and added to the above mixture to proceed chain extension before the NCO content of the dispersion has fallen to 5.41 wt %. The chain extension was continued at room temperature for 2 hours, giving an aqueous polyurethane dispersion with 0.20 wt % solid content. The dispersion was cast into a film and dried. The dried film exhibited excellent toluene resistance (over 1,000 times).

The components, tensile strength, 100% modulus and ultimate elongation of the aqueous polyurethane dispersion according to Examples 14, 10 and 11 are shown in Table 1.

TABLE 1

| | | | | | | Aqueous polyurethane | | |
|---|---|---|---|---|---|---|---|---|
| | Component (a) | | | | | dispersion characteristics | | |
| | TDI | MDI | Component | Component | Component | tensile | 100% | ultimate |
| Example | (wt %) | (wt %) | (b) | (c) | (d) | strength | modulus | elongation |
| 1 | 22.1 | 0 | 4.6 | 72.2 | 1.0 | 323 | 88 | 330 |
| 2 | 22.2 | 0 | 4.6 | 72.2 | 1.0 | 450 | 60 | 370 |
| 3 | 12.1 | 0 | 5.2 | 81.5 | 1.1 | 410 | 60 | 380 |
| 4 | 24.6 | 0 | 6.0 | 68.4 | 1.0 | 400 | 80 | 470 |
| 10 | 16.7 | 24.0 | 10.1 | 48.0 | 1.3 | 400 | 160 | 330 |
| 11 | 18.2 | 21.0 | 7.0 | 52.3 | 1.5 | 400 | 160 | 330 |

In the conventional process for producing an aqueous polyurethane dispersion, as disclosed in U.S. Pat. No. 4,801,644, the aromatic diisocyanates are reacted with polyols and a hydrophilic group-containing dihydric alcohol simultaneously to prepare an unblocked prepolymer, and the unblocked prepolymer is neutralized dispersed in water, and chain-extended at the same time. Specifically, the thus-prepared aqueous polyurethane dispersion comprises random polyurethane copolymers. Furthermore, the aqueous polyurethane dispersions based on toluene diisocyanate (TDI) and diphenylmethane diisocyanate (MDI) have superior physical properties compared with the aqueous polyurethane dispersions based entirely on toluene diisocyanate (TDI), as disclosed in U.S. Pat. No. 4,801,644.

However, in the present invention, toluene diisocyanate is reacted with component (b) and component (c) sequentially (as opposed to simultaneous reaction in U.S. Pat. No. 4,801,644) to prepare the prepolymer. The thus-prepared prepolymer has the hydrophilic groups or the groups capable of forming hydrophilicity evenly distributed among the prepolymer chains, and terminal isocyanate groups, which are relatively hydrophobic, wrapped in the internal part of twisted prepolymer chains. Accordingly, the terminal isocyanate groups are less consumed when the prepolymer is dispersed in water, and the chain extension can proceed to increase the molecular weight effectively.

Therefore, in the present invention, the aqueous polyurethane dispersions based entirely on toluene diisocyanate (TDI) have the physical properties comparable to the aqueous polyurethane dispersions based on toluene diisocyanate (TDI) and diphenylmethane diisocyanate (MDI), as shown in Table 1. Namely, the aqueous polyurethane dispersions according to the present invention can be prepared by employing toluene diisocyanate (TDI) as the only aromatic diisocyanate and has superior mechanical properties.

While the invention has been described by way of example and in terms of the preferred examples, it is to be understood that the invention is not limited to the disclosed examples. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An aqueous polyurethane dispersion, prepared by:
(A) first reacting (a) 10-40 wt % of an aromatic diisocyanate consisting of toluene diisocyanate (TDI) with (b) 1-15 wt % of a compound containing active hydrogen and a hydrophilic group or a group capable of forming hydrophilicity, to form a diisocyanate-terminated compound containing a hydrophilic group or a group capable of forming hydrophilicity;
(B) then reacting the diisocyanate-terminated compound with (c) 30-80 wt % of a polyol to form a prepolymer containing a hydrophilic group or a group capable of forming hydrophilicity, and neutralizing the prepolymer;
(C) dispersing the prepolymer in water to form an aqueous dispersion;
(D) chain-extending the dispersed prepolymer to obtain an aqueous polyurethane dispersion by adding thereto (d) 0.1-5 wt % of an amine chain extender, and the wt % is based on the total weight of components (a), (b), (c), and (d),
wherein a dried film of the aqueous polyurethane dispersion exhibits a tensile strength above 320 kg/cm² and an ultimate elongation of above 320%.

2. The aqueous polyurethane dispersion as claimed in claim 1, wherein the step (A) is conducted at a temperature of about 40-90° C.

3. The aqueous polyurethane dispersion as claimed in claim 1, wherein the polyol has a number-average molecular weight of about 200-6,000.

4. The aqueous polyurethane dispersion as claimed in claim 1, wherein (c) the polyol is selected from the group consisting of polyester polyols, polyether polyols, polycarbonate polyols, polycaprolactone polyols, polyacrylate polyols, and mixtures thereof.

5. The aqueous polyurethane dispersion as claimed in claim 1, wherein (b) the compound containing active hydrogen is capable of forming a hydrophilic group selected from the group consisting of —COO⁻, —SO₃⁻, N⁺R₄ where R is alkyl, and mixtures thereof.

6. The aqueous polyurethane dispersion as claimed in claim 1, wherein (b) the compound containing active hydrogen is selected from the group consisting of dimethylol propionic acid (DMPA), dimethylol butanoic acid (DMBA), polyethylene oxide glycol, bis(hydroxylethyl) amine, sodium 3-bis(hydroxyethyl) aminopropanesulfonate, and mixtures thereof.

7. The aqueous polyurethane dispersion as claimed in claim 1, wherein (d) the amine chain extender is a diamine, triamine, or tetraamine.

8. The aqueous polyurethane dispersion as claimed in claim 1, wherein (d) the amine chain extender is selected from the group consisting of H₂N—(CH₂)ₘ—NH₂ where m is an integer of 0-12, methyl-1,5-pentamethylene diamine, diethylene triamine (DETA), and triethylene tetraamine (TETA).

9. A method of making an aqueous polyurethane dispersion, comprising the steps of:
(A) first reacting (a) 10-40 wt % of an aromatic diisocyanate consisting of toluene diisocyanate (TDI) with (b) 1-15 wt % of a compound containing active hydrogen and a hydrophilic group or a group capable of forming hydrophilicity, to form a diisocyanate-terminated compound containing a hydrophilic group or a group capable of forming hydrophilicity;
(B) then reacting the diisocyanate-terminated compound with (c) 30-80 wt % of a polyol to form a prepolymer containing a hydrophilic group or a group capable of forming hydrophilicity, and neutralizing the prepolymer;
(C) dispersing the prepolymer in water to form an aqueous dispersion; and
(D) chain-extending the dispersed prepolymer to obtain an aqueous polyurethane dispersion by adding thereto (d) 0.1-5 wt % of an amine chain extender, and the wt % is based on the total weight of components (a), (b), (c), and (d),
wherein a dried film of the aqueous polyurethane dispersion exhibits a tensile strength above 320 kg/cm² and an ultimate elongation of above 320%.

10. The method as claimed in claim 9, wherein the step (A) is conducted at a temperature of about 40-90° C.

11. The method as claimed in claim 9, wherein the polyol has a number-average molecular weight of about 200-6,000.

12. The method as claimed in claim 9, wherein (C) the polyol is selected from the group consisting of polyester polyols, polyether polyols, polycarbonate polyols, polycaprolactone polyols, polyacrylate polyols, and mixtures thereof.

13. The method as claimed in claim 9, wherein (b) the compound containing active hydrogen is capable of forming a hydrophilic group selected from the group consisting of —COO⁻, —SO₃⁻, N⁺R₄ where R is alkyl, and mixtures thereof.

14. The method as claimed in claim 9, wherein (b) the compound containing active hydrogen is selected from the group consisting of dimethylol propionic acid (DMPA), dimethylol butanoic acid (DMBA), polyethylene oxide glycol, bis(hydroxylethyl) amine, sodium 3-bis(hydroxyethyl) aminopropanesulfonate, and mixtures thereof.

15. The method as claimed in claim 9, wherein (d) the amine chain extender is a diamine, triamine, or tetraamine.

16. The method as claimed in claim 9, wherein (d) the amine chain extender is selected from the group consisting of H₂N—(CH₂)ₘ—NH₂ where m is an integer of 0-12, methyl-1,5-pentamethylene diamine, diethylene triamine (DETA), and triethylene tetraamine (TETA).
